(19) United States
(12) Patent Application Publication
(10) Pub. No.: US 2020/0033699 A1
(43) Pub. Date: Jan. 30, 2020

(54) CAMERA MODULE

(71) Applicant: MDPULSE CO., LTD., Gumi-si (KR)

(72) Inventor: Jin Kuk KIM, Cheonan-si (KR)

(21) Appl. No.: 15/738,531

(22) PCT Filed: Jan. 20, 2016
(86) PCT No.: PCT/KR2016/000604

§ 371 Date: Dec. 20, 2017

(30) Foreign Application Priority Data
Feb. 17, 2015 (KR) 10-2015-0024070

(51) Int. Cl. G03B 13/36; G02B 7/09; G02B 27/64; G03B 5/04

(52) U.S. Cl. CPC G03B 13/36; G02B 7/09; G03B 2205/0069; G03B 5/04; G03B 2205/0015; G02B 27/646

(57) ABSTRACT

Disclosed is a camera module capable of simplifying a structure and facilitating assembly and disassembly. The camera module includes a lens unit, an AF assembly which adjusts advance and retreat movement in an optical axis direction of the lens unit, and an OIS assembly which is provided as an independent module structurally separated from the AF assembly and allows the AF assembly to move in a direction vertical to the optical axis direction of the lens unit, and the AF assembly and the OIS assembly are provided separately and assemblably in an independent modularized to each other.

### TECHNICAL FIELD

The present invention relates to a camera module capable of simplifying a structure and enabling easy assembling and disassembling.

### BACKGROUND ART

The number of portable devices equipped with small and lightweight camera modules is gradually increased.

Recently, according to a need for a high-definition camera, an autofocus (AF) function is applied. The AF function may acquire a clear image on an imaging plane of an image sensor by moving a lens positioned in front of an image sensor in an optical axis direction according to a distance from a subject.

As another of techniques for improving performance of the camera, there is an optical image stabilization (OIS) function. The OIS function is a technique for compensating for shaking on the subject due to vibration of a human body such as shaking of a user, and a technique of detecting vibration applied to a device by a plurality of angular velocity sensors mounted on an electronic device and moving a lens or an image sensor according to the angular velocity and direction of the detected vibration.

However, when both an AF unit and an OIS unit are simultaneously adopted, there is a problem in that the structure of the camera module is complicated and assembly and disassembly are difficult. Particularly, in the related art, for miniaturization and slimness of the camera module, since the AF unit and the OIS unit are fabricated in approximately one assembly form without a structure distinction for each unit, there is a problem in that assembly and disassembly are troublesome and inconvenient. In addition, in the related art, when any one of the AF unit and the OIS unit is replaced, there is a problem in that it is inevitably necessary to disassemble the other unit together.

### DISCLOSURE

### Technical Problem

An object of the present invention is to provide a camera module capable of simplifying a structure and enabling easy assembling and disassembling.

Particularly, another object of the present invention is to provide a camera module in which an AF assembly and an OIS assembly are independent assembly forms, respectively, to be structurally separated from each other.

Yet another object of the present invention is to provide a camera module capable of improving driving stability and reliability of an OIS unit.

### Technical Solution

An exemplary embodiment of the present invention provides a camera module including a lens unit; an AF assembly which adjusts advance and retreat movement in an optical axis direction of the lens unit; and an OIS assembly which is provided as an independent module which can be structurally separated from the AF assembly and allows the AF assembly to move in a direction vertical to the optical axis direction of the lens unit. The AF assembly and the OIS assembly are provided separately and assemblably in an independent modularized to each other.

In the present invention, the fact that the AF assembly and the OIS assembly are independently modularized to each other should be understood as a state in which the AF assembly and the OIS assembly are independently assembled and modularized without sharing a specific component.

As the AF assembly, various structures capable of moving the lens unit in the optical axis direction may be used. For example, the AF assembly may include an AF housing, a lens carrier on which the lens unit is mounted and accommodated in the AF housing to be movable in the optical axis direction of the lens unit, and an AF driver which provides driving force so that the lens carrier is moved.

The structure of the AF driver may be variously changed according to requirements and design specifications. For example, the AF driver may include an AF magnet which is mounted on the lens carrier to be vertically disposed in the optical axis direction of the lens unit, and an AF coil which is mounted on the AF housing in parallel with the AF magnet. In some cases, the AF coil may be mounted on the lens carrier and the AF magnet may be mounted on the AF housing.

Further, the position control of the AF magnet may be variously changed according to requirements and design specifications. As an example, for the position control of the AF magnet, an AF sensing unit for sensing the position of the AF magnet may be provided and perform the position control of the AF magnet using a signal sensed in the AF sensing unit. In some case, for the position control of the AF magnet, it is possible to control the position of the AF magnet by adjusting a voltage applied to the AF coil without using a separate AF sensing unit such as a hall sensor.

The OIS assembly may be provided in various structures which may be provided by an independent module. As an example, the OIS assembly may include a base frame, a movable frame provided movably in a direction vertical to the optical axis direction of the lens unit about the base frame, and an OIS driver which provides driving force so that the movable frame moves about the base frame. Herein, the direction vertical to the optical axis (a Z coordinate direction) of the lens unit should be understood as X and Y-coordinate directions which are horizontal to the upper surface of the base frame.

The OIS driver may be provided in various structures which may provide driving force so that movable frame moves about the base frame. As an example, the driver may include an OIS coil mounted horizontally on the base frame and an OIS magnet disposed horizontally on the upper portion of the OIS coil and fixed to the movable frame.

Further, the number and arrangement of the OIS coil and the OIS magnet may be variously changed according to requirements and design specifications. As an example, four OIS coils and OIS magnets may be provided, and each OIS coil and each OIS magnet may be disposed along the outer sides of the base frame. In some cases, the OIS coils and the OIS magnets may be disposed at the corner of the base frame.

Further, the number and the shapes of the OIS magnet and the OIS coil may be variously changed according to requirements and design specifications. As an example, the OIS magnet may be formed in a rectangular shape. In some cases, the OIS magnet may be formed in other polygonal shapes such as a trapezoid shape. Further, the OIS magnet may be formed to have a longer length or a shorter length than the OIS coil.

Further, the OIS driver may include an OIS yoke which is disposed below the OIS coil so that mutual attraction with the OIS magnet is applied. The OIS yoke may hold the flow and tilting of the movable frame to the base frame in the optical axis direction (a Z coordinate direction) by mutual attraction with the OIS magnet.

The position control of the OIS magnet may be variously changed according to requirements and design specifications. As an example, for the position control of the OIS magnet, an OIS sensing unit for sensing the position of the OIS magnet may be provided and perform the position control of the OIS magnet using a signal sensed in the OIS sensing unit. Alternatively, for the position control of the OIS magnet, it is possible to control the position of the OIS magnet by adjusting a voltage applied to the OIS coil without using a separate OIS sensing unit such as a hall sensor.

Further, the elastic member may be provided between the AF assembly and the OIS assembly and the elastic member may provide elastic force to the movable frame in a horizontal direction which is a vertical direction to the optical axis. Since the movable frame moves in the horizontal direction about the base frame at the time of the OIS operation, the elastic member of the present invention may be required to movably support the movable frame to the base frame. The function is not limited to the horizontal support function, and the elastic member may achieve a pre-loading function so that movable frame may return to the initial position of the optical axis direction to the base frame by pressing the movable frame in the optical axis direction. The elastic member may provide the elastic force so that the movable frame may return to the initial position in which is aligned with the base frame in the optical axis direction. In a preferable case, the elastic member may elastically support the movable frame in the horizontal direction and elastically support the movable frame in the optical axis direction at the same time. Accordingly, only the elastic member may serve as both an OIS suspension function and an optical axis direction pre-loading function.

The elastic member may have various structures capable of returning to the initial position of the optical axis direction or providing the elastic force capable of elastically supporting the movable frame in the horizontal direction. As an example, the elastic member may include a first connection portion rotatably connected to the base frame, a second connection portion rotatably connected to the movable frame 420, and an elastic bending portion connecting integrally the first connection portion and the second connection portion, and the first connection portion, the second connection portion, and the elastic bending portion may be formed in a single body to form a single layer.

The shape of the elastic bending portion may be appropriately changed according to requirements and design specifications. As an example, the elastic bending portion may be formed in a zigzag shape which is elastically deformable in the moving direction along the horizontal direction of the movable frame to the base frame or a moving direction along the optical axis direction. Alternatively, the elastic bending portion may be formed in a spiral shape or a triangular shape. Further, at least one reinforced bending portion may be formed at the elastic bending portion.

Further, the first connection portion and the second connection portion are disposed to have a difference in height in the optical axis direction and are connected to each other by the elastic bending portion, and may be used as a means for pre-loading elastically the movable frame in the optical axis direction.

As the pre-load means for allowing the movable frame to be at the initial position in the optical axis direction to the base frame, various examples such as using only the elastic member, using only the OIS yoke, or using the elastic member and the OIS together are possible.

The number and arrangement of the elastic members may be variously changed according to requirements. Preferably, one end of the elastic member may be connected to a corner portion of the base frame and the other end thereof may be connected to the corner portion of the movable frame.

Meanwhile, the AF assembly and the OIS assembly may be electrically connected to each other through the elastic member. To this end, the elastic member may be made of a general conductive material such as a metal. Further, the elastic member may be connected to respective terminals of the AF connecting member and the OIS connecting member using a conductive resin.

The OIS assembly may be provided with a guide means for allowing the movable frame to move more smoothly about the base frame. The structure of the guide means may be variously changed according to requirements and design specifications. As an example, the guide means may include a guide ball provided to be rollably movable between the base frame and the movable frame, and a ball accommodation portion for accommodating the guide ball may be formed in at least one of the base frame and the movable frame.

### Advantageous Effects

According to the camera module of the present invention, it is possible to simplify a structure and facilitate assembly and disassembly.

Particularly, according to the present invention, since an AF assembly and an OIS assembly may be structurally separated from each other in independent assembly forms, it is possible to simplify the overall structure and more simplify a process of assembling or dissembling the AF assembly and the OIS assembly.

In the related art, since at least some of OIS components constituting the OIS assembly are mounted together on AF components constituting the AF assembly, there is inconvenience that it is necessary to separate the AF components inevitably in order to replace a specific component of the OIS components. However, in the present invention, since the AF assembly and the OIS assembly may be provided to be independently modularized, it is possible to separate only a specific component required for being replaced from the OIS assembly without separating the AF components in order to replace the OIS components. Further, it is possible to simply assemble two types of modules modularized even in assembling.

Further, according to the present invention, since the AF assembly and the OIS assembly may be provided in the form of the pre-assembled modules, respectively, it is possible to prevent misassembly and shorten the assembling and disassembling time.

Further, according to the present invention, the OIS driver and the elastic member may be installed at the corner of the base frame, thereby improving spatial utilization and design freedom of products.

Further, according to the present invention, the OIS yoke to which the mutual attraction with the OIS magnet is applied is disposed below the OIS coil, thereby preventing abnormal flow and tilting of the lens unit in the optical axis direction. Such a function may be also be achieved by the geometric shape of the elastic member. The geometric shape of the elastic member may exemplify that the first connecting portion and the second connecting portion are arranged so as to have a height difference in the optical axis direction and are connected to each other by an elastic bend portion.

In addition, according to the present invention, the elastic member is formed to form a single layer and may be disposed on the boundary between the AF assembly and the OIS assembly, thereby contributing to miniaturization and thinning of the product while securing sufficient spring force. Furthermore, since the elastic member is made of a conductive material and may electrically connect the AF assembly and the OIS assembly to each other, thereby more simplifying the electric connection structure of the respective assemblies.

The elastic member of the present invention may simultaneously perform an OIS suspension function of supporting the movable frame in the horizontal direction when the OIS operates, a pre-load function of aligning the movable frame to the initial position of the optical axis direction, and an electrical connection function of electrically connecting the coil, the hall sensor, or the like.

Further, according to the present invention, the connection between the elastic member and the connection member may be made by the conductive resin instead of the conventional soldering, thereby simplifying a structure and a manufacturing process compared to an existing connection structure.

### DESCRIPTION OF DRAWINGS

FIGS. 1 and 2 are diagrams illustrating a camera module according to the present invention.

FIG. 3 is a diagram for describing an AF assembly as the camera module according to the present invention.

FIG. 4 is a diagram for describing an OIS assembly as the camera module according to the present invention.

FIGS. 5 and 6 are diagrams for describing an internal structure of the camera module according to the present invention.

Meanwhile, FIGS. 7 and 8 are diagrams for describing a camera module according to another exemplary embodiment of the present invention.

### MODES OF THE INVENTION

Hereinafter, preferred embodiments of the present invention will be described in detail with reference to the annexed drawings, but should be not construed as limiting or restricting the present invention. For reference, in the present invention, like reference numerals designate substantially like constituent elements, the contents disclosed in different drawings under the rule can be cited and described, and the contents which are determined to be apparent to those skilled in the art or repeated can be omitted.

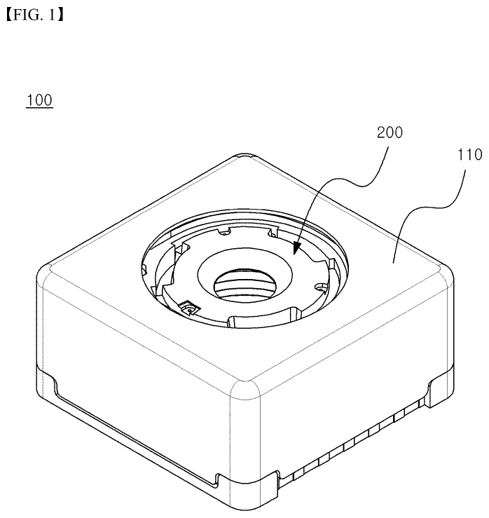

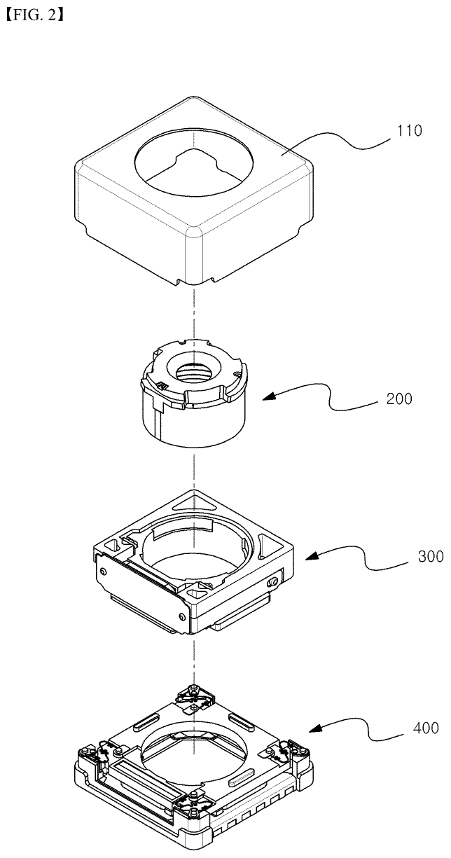

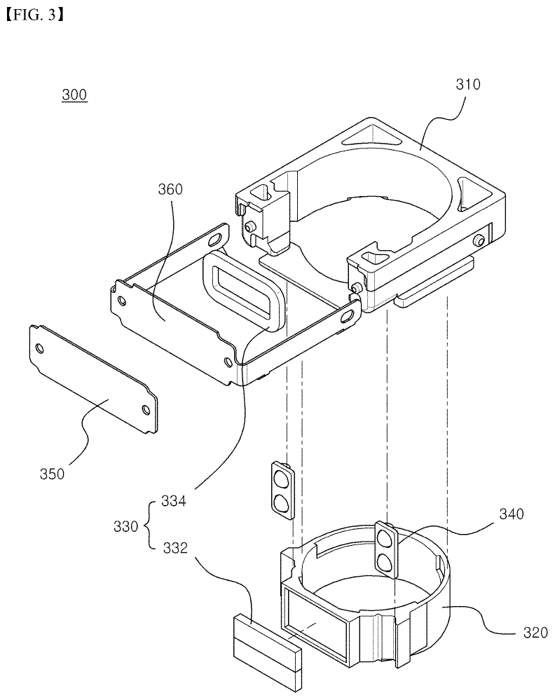

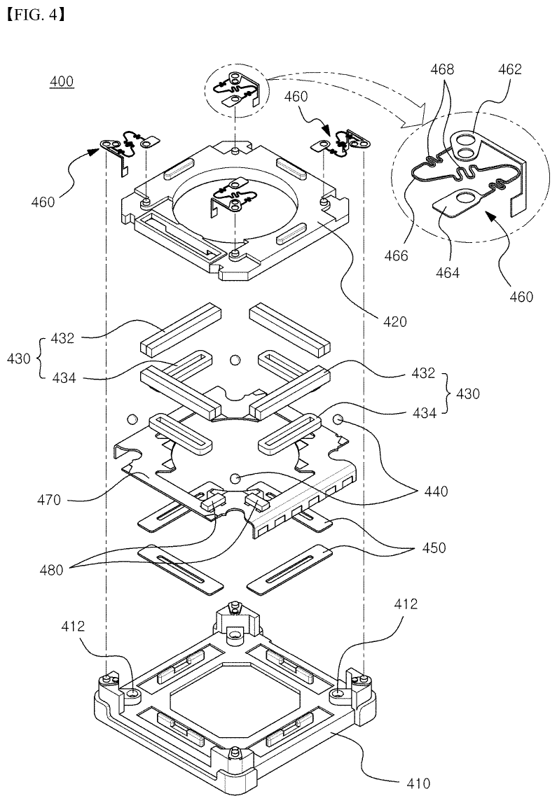

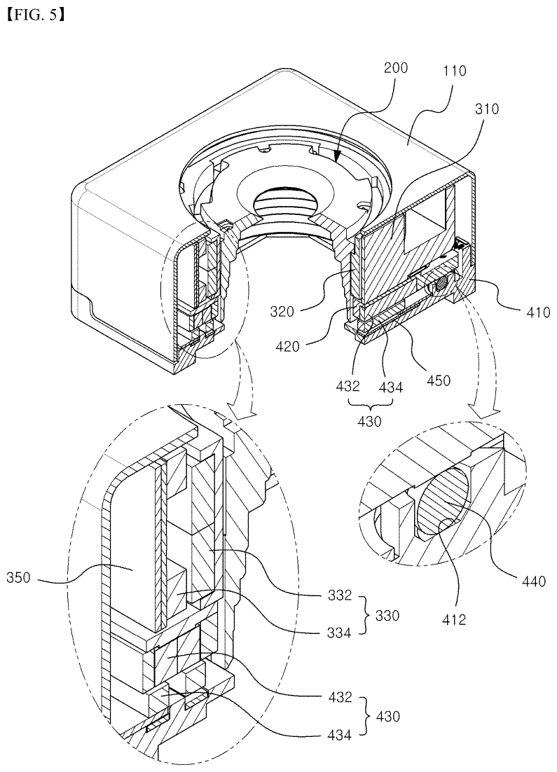

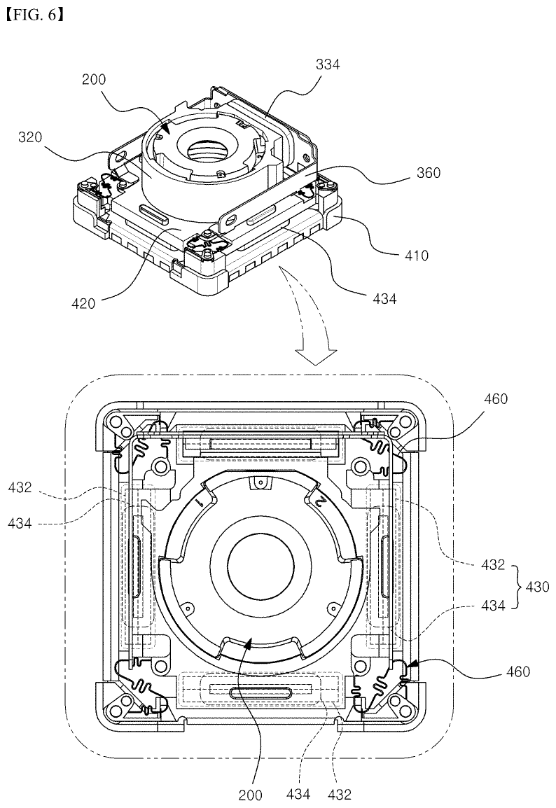

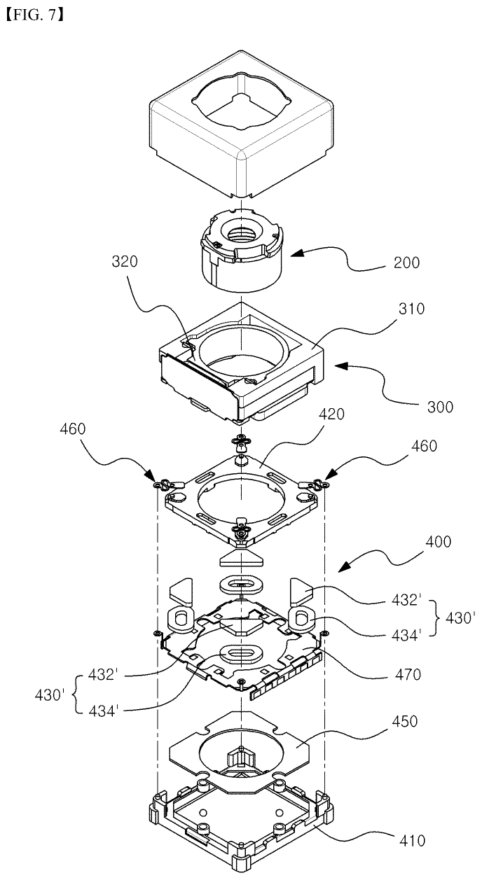

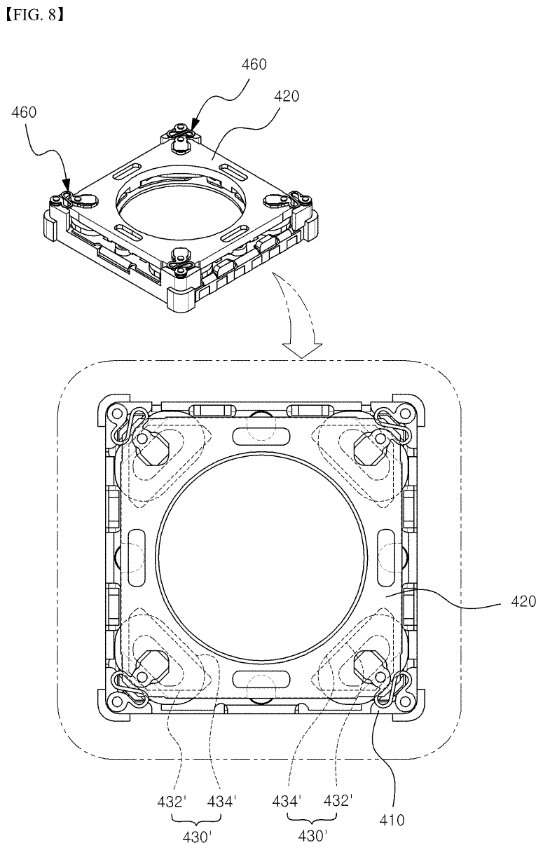

FIGS. 1 and 2 are diagrams illustrating a camera module according to the present invention, and FIG. 3 is a diagram for describing an AF assembly as the camera module according to the present invention. Further, FIG. 4 is a diagram for describing an OIS assembly as the camera module according to the present invention and FIGS. 5 and 6 are diagrams for describing an internal structure of the camera module according to the present invention.

Referring to FIGS. 1 to 6, a camera module 100 according to the present invention includes a lens unit 200, an AF assembly 300, and an OIS assembly 400.

The lens unit 200 includes a lens housing and a single lens or plural lenses mounted on the lens housing. As the lens unit 200, a general lens unit 200 may be used, and the present invention is not limited or restricted by a type and characteristics of the lens unit 200.

An image sensor for storing light focused by the lens unit 200 as an image may be provided below the lens unit 200. For example, the image sensor may be mounted on a flexible PCB and may be connected to an electronic device equipped with the camera module 100, for example, an image processing apparatus such as a digital camera, a mobile communication terminal, a tablet PC, and the like.

The AF assembly 300 is provided to move the lens unit 200 positioned in front of the image sensor in an optical axis direction according to the distance from a subject, and the AF assembly 300 and the OIS assembly 400 are provided to be separated from or assembled with each other in an independently modularized state.

For reference, in the present invention, the fact that the AF assembly 300 and the OIS assembly 400 are modularized independently to each other should be understood as a state in which the AF assembly 300 and the OIS assembly 400 are independently assembled and modularized without sharing a specific component with each other.

In the related art, since at least some of OIS components constituting the OIS assembly 400 are mounted together on AF components constituting the AF assembly 300, there is inconvenience that it is necessary to separate the AF components inevitably in order to replace a specific component of the OIS components. However, in the present invention, since the AF assembly 300 and the OIS assembly 400 may be provided to be independently modularized, it is possible to separate only a specific component required for being replaced from the OIS assembly 400 without separating the AF components in order to replace the OIS components. Further, it is possible to simply assemble two types of modules modularized even in assembling.

As the AF assembly 300, various structures capable of moving the lens unit 200 in the optical axis direction may be used. For example, the AF assembly 300 may include an AF housing 310, a lens carrier 320, and an AF driver 330.

The AF housing 310 is provided to have a predetermined accommodation space therein and the lens carrier 320 is coupled with the lens unit 200 and may be accommodated in the AF housing 310 to be movable in the optical axis direction of the lens unit 200.

As the AF driving unit 330, various driving units capable of providing the driving force required for moving the lens carrier 320 may be used. For example, the AF driver 330 may include an AF magnet 332 mounted on the lens carrier 320 so as to be vertically arranged in the optical axis direction of the lens unit 200, and an AF coil 334 which is mounted on the AF housing 310 to be disposed in parallel with the AF magnet 332. In some cases, the AF coil may be mounted on the lens carrier and the AF magnet may be mounted on the AF housing.

For reference, in the present invention, an example in which a magnet having a bipolar structure on one surface is used as the AF magnet 332 will be described. In some cases, it is also possible to use magnets magnetized with other structures as the AF magnet.

The AF magnet 332 moves in the optical axis direction by the mutual electromagnetic action between the AF magnet 332 and the AF coil 334 in a direction in which the current is applied to the AF coil 334 to provide the driving force required for movement of the lens carrier 320.

Meanwhile, the position control of the AF magnet 332 may be variously changed according to requirements and design specifications. For example, for the position control of the AF magnet 332, an AF sensing unit (not illustrated) for sensing the position of the AF magnet 332 may be provided and may perform the position control of the AF magnet 332 using a signal sensed in the AF sensing unit. As the AF sensing unit, a general hall sensor may be used, and in some cases, other sensors may be used. Alternatively, for the position control of the AF magnet, it is possible to control the position of the AF magnet by adjusting a voltage applied to the AF coil without using a separate AF sensing unit such as a hall sensor.

In addition, an AF guide means 340 may be provided between the AF housing 310 and the lens carrier 320 to guide movement of the lens carrier 320 in the optical axis direction. As the AF guide means 340, a guide device using a normal rod, a ball, or the like may be used, and the present invention is not limited or restricted by the type and characteristics of the AF guide means 340. An AF yoke 350, to which attraction with the AF magnet 332 is applied, may be provided at the rear side of the AF coil 334.

The OIS assembly 400 is provided to compensate for shaking on a subject due to vibration of a human body such as shaking of a user during photographing and the OIS assembly 400 may be provided in a modularized state as a single module separately from the AF assembly 300.

The AF assembly 400 may be provided in various structures which can be provided as independent modules. For example, the OIS assembly 400 may include a base frame, a movable frame 420, and an OIS driver 430.

The base frame may be provided in a substantially rectangular plate structure and the movable frame 420 is provided on the upper surface of the base frame to be movable in a horizontal direction which is a direction vertical to the optical axis of the lens unit 200. Herein, the horizontal direction, which is the direction vertical to the optical axis (a Z coordinate direction) of the lens unit 200, should be understood as X and Y coordinate directions which are horizontal to the upper surface of the base frame.

The OIS driver 430 may be provided in various structures capable of providing a driving force so that the movable frame 420 moves about the base frame. For example, the OIS driver 430 includes an OIS coil 434 mounted on the base frame in a horizontal direction (X, Y coordinate directions), and an OIS magnet 432 which is disposed horizontally on the OIS coil 434 and fixed to the movable frame 420.

In the direction in which the current is applied to the OIS coil 434, the OIS magnet 432 moves in a direction (X, Y coordinate directions) vertical to the optical axis direction by the mutual electromagnetic action between the OIS magnet 432 and the OIS coil 434 to provide the driving force required for movement of the movable frame 420.

The number and arrangement of the OIS coil 434 and the OIS magnet 432 may be variously changed according to requirements and design specifications. For example, four OIS coils 434 and OIS magnets 432 may be provided, and each OIS coil 434 and each OIS magnet 432 may be disposed along the outer side of the base frame. Two OIS coils 434 and OIS magnets 432 disposed on opposite sides of the four OIS coils 434 and the OIS magnets 432 may provide driving force in an X-coordinate direction, and two OIS coils 434 and OIS magnets 432 disposed on the other opposite sides of the four OIS coils 434 and the OIS magnets 432 may provide driving force in the Y-coordinate direction. In some cases, it is possible to use three or less, or five or more OIS coils and OIS magnets.

Further, the number and the shapes of the OIS magnet 432 and the OIS coil 434 may be variously changed according to requirements and design specifications. Hereinafter, an example, in which the OIS magnet 432 is formed in a rectangular shape and is formed to have a longer length than the OIS coil 434, will be described. Herein, it should be understood that the fact that the OIS magnet 432 has a longer length than the OIS coil 434 (for example, the length along the outer side of the base frame) means that when both ends of the OIS coil 434 are disposed at insides of both ends of the OIS magnet 432 during planar projection. In some cases, the OIS magnet may be formed to have a shorter length than the OIS coil.

Meanwhile, in order to move the lens carrier 320 in the optical axis direction, a predetermined height in the optical axis direction may be necessarily secured, and since the AF magnet 332 and the AF coil 334 are disposed on the predetermined height, an increase in height by the AF magnet 332 and the AF coil 334 does not occur. However, since the OIS assembly 400 including the OIS coil 434 and the OIS magnet 432 is mounted below the AF assembly 300 separately from the AF assembly 300, the overall height of the product increases as the height occupied by the OIS coil 434 and the OIS magnet 432 is increased. As a result, in the present invention, the height of the OIS coil 434 and the OIS magnet 432 may be minimized by horizontally mounting the OIS coil 434 and the OIS magnet 432.

Further, the OIS driver 430 may include an OIS yoke 450 disposed below the OIS coil 434 so that mutual attraction with the OIS magnet 432 is applied.

The OIS yoke 450 may hold the flow and tilting of the movable frame 420 to the base frame in the optical axis direction (a Z coordinate direction) by mutual attraction with the OIS magnet 432, and as a result, abnormal flow and tilting of the lens unit 200 in the optical axis direction may be prevented. Such a pre-loading function may be achieved by an elastic member 460.

However, the attraction between the OIS yoke 450 and the OIS magnet 432 needs to be smaller than electromagnetic force between the OIS coil 434 and the OIS magnet 432 described above, and the attraction between the OIS yoke 450 and the OIS magnet 432 may be adjusted to correspond to the electromagnetic force between the OIS coil 434 and the OIS magnet 432.

As the OIS yoke 450, a general metallic material such as steel use stainless (SUS) may be used, and the material and characteristics of the OIS yoke 450 may be appropriately changed according to requirements and design specifications.

Meanwhile, the position control of the OIS magnet 432 may be variously changed according to requirements and design specifications. For example, for the position control of the OIS magnet 432, an OIS sensing unit 480 for sensing the position of the OIS magnet 432 may be provided and may perform the position control of the OIS magnet 432 using a signal sensed in the OIS sensing unit 480. As the OIS sensing unit 480, a general hall sensor may be used, and in some cases, other sensors may be used. Alternatively, for the position control of the OIS magnet, it is possible to control the position of the OIS magnet by adjusting a voltage applied to the OIS coil without using a separate OIS sensing unit such as a hall sensor.

Further, an elastic member 460 may be provided between the AF assembly 300 and the OIS assembly 400. The elastic member 460 may achieve a pre-load function that provides the elastic force so that the movable frame 420 may return to the initial position in which is aligned with the base frame in the optical axis direction of the lens unit 200. In addition, an OIS suspension function to elastically support the movable frame 420 in a horizontal direction may be provided.

The elastic member 460 may have various structures capable of providing the elastic force capable of returning the movable frame 420 to the initial position. For example, the elastic member 460 may include a first connection portion 462 rotatably connected to the base frame, a second connection portion 464 rotatably connected to the movable frame 420, and an elastic bending portion 466 connecting integrally the first connection portion 462 and the second connection portion 464, and the first connection portion 462, the second connection portion 464, and the elastic bending portion 466 may be formed in a single body to form a single layer.

The shape of the elastic bending portion 466 may be appropriately changed according to requirements and design specifications. For example, the elastic bending portion 466 may be formed in a zigzag shape which is elastically deformable in the moving direction of the movable frame 420 about the base frame.

As such, in the present invention, sufficient spring force may be secured by providing the elastic bending portion 460 bent in a zigzag shape while minimizing a height (thickness) by constituting the elastic member 460 in a single-layer form.

Further, at least one reinforced bending portion 468 may be formed at the elastic bending portion 466. For example, the reinforced bending portion 468 has a substantially zigzag shape and a plurality of reinforced bending portions 468 may be provided to be spaced apart from each other at predetermined intervals to have a relatively smaller size than the elastic bending portion 466. Such a structure may be elastically deformed by the elastic bending portion 466 and the reinforced bending portion 468 so that the elastic force by the elastic member 460 may be provided more smoothly and stably.

The number and arrangement of the elastic members 460 may be variously changed according to requirements. For example, in the four elastic members 460, one end thereof may be connected to a corner portion of the base frame, and the other end thereof may be connected to a corner portion of the movable frame 420. Such a structure may minimize a space in which the elastic member 460 is mounted and maximize an elastic deformation space of the elastic member 460. In some cases, the elastic member may be disposed at a side or other position other than the corner of the base frame, and also, three or less or five or more elastic members may be used.

Meanwhile, an AF connection member 360 (for example, FPCB) for electrical connection may be connected to the AF assembly 300, an OIS connection member 470 for electrical connection may be connected to the OIS assembly 400, and the AF assembly 300 and the OIS assembly 400 may be electrically connected to each other through the elastic member 460. To this end, the elastic member 460 may be made of a general conductive material such as a metal.

Further, the elastic member 460 may be connected to respective terminals of the AF connecting member 360 and the OIS connecting member 470 using a conductive resin. For example, the elastic member 460 may be connected to respective terminals of the AF connecting member 360 and the OIS connecting member 470 using a conductive epoxy resin. As such, the connection structure using the conductive resin has an advantage of simplifying the structure and the manufacturing process compared with an existing connection structure using soldering.

In addition, the OIS assembly 400 may be provided with a guide means for allowing the movable frame 420 to move more smoothly about the base frame.

The structure of the guide means may be variously changed according to requirements and design specifications. For example, the guide means may include a guide ball 440 provided to be rollably movable between the base frame and the movable frame 420, and in at least one of the base frame and the movable frame 420, a ball accommodation portion for accommodating the guide ball 440 may be formed. Hereinafter, an example in which a ball accommodation portion for partially accommodating the guide ball 440 is formed on the base frame will be described. In some cases, it is also possible to form a ball accommodation portion in the movable frame or form ball accommodation portions in both the base frame and the movable frame.

Hereinafter, an example in which four guide balls 440 and a ball accommodation portion are provided in the vicinity of the corner of the base frame will be described. The number and the arrangement of the guide balls 440 and the ball accommodation portion may be appropriately changed according to requirements and design specifications.

The ball accommodation portion may prevent the guide ball 440 from being detached due to a shock or the like while keeping the arrangement state of the guide balls 440. For reference, in the present invention, an example in which the ball accommodation portion is formed as a kind of groove is described, but in some cases, a rib-shaped ball accommodation portion may be formed.

In addition, after the AF assembly 300 and the OIS assembly 400 described above are assembled, a cover housing 110 may be coupled to cover the AF assembly 300 and the OIS assembly 400.

Meanwhile, FIGS. 7 and 8 are diagrams for describing a camera module 100 according to another exemplary embodiment of the present invention. Furthermore, the same and equivalent parts as the aforementioned configurations designate the same or equivalent reference numerals, and the detailed description thereof will be omitted.

In the exemplary embodiment of the present invention described and illustrated above, although the OIS coil 434 and the OIS magnet 432 constituting the OIS assembly 400 are disposed along the side of the base frame, the OIS magnet 434 and the OIS magnet 432 are arranged in other structures.

Referring to FIGS. 7 and 8, a camera module 100 according to another exemplary embodiment of the present invention includes a lens unit 200, and an AF assembly 300 and an OIS assembly 400 which are provided to be independently modularized, and the OIS assembly 400 includes a base frame, a movable frame 420, and an OIS driver 430, and an OIS coil 434 and an OIS magnet 432 constituting the OIS coil 430 may be disposed at the corner portion of the base frame.

Further, in the above-described exemplary embodiment, an example in which the OIS magnet having a rectangular shape is used is described. However, according to another exemplary embodiment of the present invention, the OIS magnet may be formed in other polygonal shapes. For example, as illustrated in FIGS. 7 and 8, the OIS magnet 432 may be formed in a substantially trapezoidal shape.

As described above, although the present invention has been disclosed with reference to the preferred embodiments, those skilled in the art will appreciate that various modifications, additions and substitutions are possible, without departing from the scope and spirit of the invention as disclosed in the accompanying claims.

1. A camera module, comprising:
a lens unit;
an AF assembly which adjusts advance and retreat movement in an optical axis direction of the lens unit;
an OIS assembly which moves the AF assembly in a direction vertical to the optical axis direction of the lens unit; and
an elastic member which pre-loads the AF assembly to an initial position in the optical axis direction or elastically supports the AF assembly in a horizontal direction which is a direction vertical to the optical axis when the OIS function operates.

2. The camera module of claim 1, wherein the OIS assembly includes a base frame, a movable frame provided movably in a direction vertical to the optical axis direction of the lens unit about the base frame; and an OIS driver which provides driving force so that the movable frame moves about the base frame.

3. The camera module of claim 2, wherein the elastic member elastically connects the movable frame and the base frame, and the elastic member provides elastic force so that the movable frame returns to the initial position in which is aligned with the base frame in the optical axis direction or elastically supports the movable frame in a direction vertical to the optical axis.

4. The camera module of claim 1, wherein the AF assembly and the OIS assembly are provided as independent modules that are structurally separable and are provided to be separated and assembled in an independently modularized state.

5. The camera module of claim 1, wherein the elastic member is provided between the AF assembly and the OIS assembly.

6. The camera module of claim 1, wherein the elastic member is made of a conductive material, and the AF assembly and the OIS assembly are electrically connected by the elastic member.

7. The camera module of claim 1, wherein the elastic member is connected to the AF assembly and the OIS assembly using a conductive resin.

8. The camera module of claim 1, wherein the OIS assembly includes a base frame, a movable frame provided to be movable in a direction vertical to the optical axis direction of the lens unit about the base frame, and an OIS driver which provides driving force so that the movable frame moves about the base frame, and
the elastic member includes a first connection portion rotatably connected to the base frame, a second connection portion forming a single layer with the first connection portion and rotatably connected to the movable frame, and an elastic bending portion forming a single layer with the second connection portion and connecting integrally the first connection portion and the second connection portion.

9. The camera module of claim 1, wherein the OIS assembly includes a base frame, a movable frame provided movably in a direction vertical to the optical axis direction of the lens unit about the base frame, and an OIS driver which provides driving force so that the movable frame moves about the base frame.
the elastic member includes an elastic bending portion which integrally connects a first connection portion and a second connection portion, and
the elastic bending portion is formed in a zigzag shape which is elastically deformable in a moving direction of the movable frame about the base frame.

10. The camera module of claim 1, wherein the elastic member includes an elastic bending portion which integrally connects a first connection portion and a second connection portion, and the elastic bending portion has at least one reinforced bending portion.

11. The camera module of claim 1, wherein the OIS assembly includes a base frame, a movable frame provided movably in a direction vertical to the optical axis direction of the lens unit about the base frame, and an OIS driver which provides driving force so that the movable frame moves about the base frame, and
the OIS driver includes an OIS coil mounted horizontally on the base frame; and an OIS magnet disposed horizontally at the upper portion of the OIS coil and fixed to the movable frame.

12. The camera module of claim 1, wherein the OIS assembly includes an OIS coil, an OIS magnet opposed thereto, and an OIS yoke disposed below the OIS coil so that mutual attraction with the OIS magnet is applied.

13. The camera module of claim 1, wherein an OIS coil is disposed on a base frame and an OIS magnet opposed to the OIS coil is disposed on a movable frame, respectively, and
wherein the OIS coil is disposed along an outer side of the base frame or disposed at a corner of the base frame.

14. The camera module of claim 1, wherein an OIS coil and an OIS magnet which are opposed to each other are provided, and the OIS magnet is formed in a rectangular shape or a trapezoid shape.

15. The camera module of claim 1, wherein an OIS coil and an OIS magnet which are opposed to each other are provided, and
wherein a position of the OIS magnet is controlled by using a signal sensed in an OIS sensing unit sensing the position of the OIS magnet, or by adjusting a voltage applied to the OIS coil.

16. The camera module of claim 1, wherein the OIS assembly includes a base frame, a movable frame movable in a horizontal direction about the base frame, and a guide means which guides the movement of the movable frame about the base frame.

17. The camera module of claim 16, wherein the guide means includes a guide ball provided to be rollably movable between the base frame and the movable frame, and a ball accommodation portion for accommodating the guide ball is formed in at least one of the base frame and the movable frame.

18. The camera module of claim 1, wherein the AF assembly includes
an AF housing;
a lens carrier in which the lens unit is mounted and which is accommodated in the AF housing to be movable in the optical axis direction of the lens unit; and
an AF driver which provides driving force to move the lens carrier.

19. The camera module of claim 18, wherein the AF driver includes
an AF magnet which is mounted on the lens carrier to be vertically disposed in the optical axis direction of the lens unit; and
an AF coil which is mounted on the AF housing to face the AF magnet.

20. The camera module of claim 19, wherein the position of the AF magnet is controlled by using a signal sensed in an AF sensing unit sensing the position of the AF magnet, or by adjusting a voltage applied to the AF coil.
